(19) United States
(12) Patent Application Publication
(10) Pub. No.: US 2026/0154611 A1
(43) Pub. Date: Jun. 4, 2026

(54) METHODS FOR TRANSMITTER SIDE TRAINING FOR ONLINE CONSTELLATION LEARNING

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); Daniel Steinbach, Commack, NY (US)

(73) Assignee: InterDigital Patent Holdings, Inc., Wilmington, DE (US)

(21) Appl. No.: 18/968,371

(22) Filed: Dec. 4, 2024

(51) Int. Cl. G06N 20/00; H04L 27/34

(52) U.S. Cl. CPC G06N 20/00; H04L 27/3483

(57) ABSTRACT

A wireless transmit/receive unit (WTRU) may receive first configuration information from a network device. The first configuration information may comprise one or more initial constellations associated with an AI/ML constellation model. The WTRU may receive second configuration information from the network device. The second configuration information indication may comprise an allocation associated with online constellation learning training. The WTRU may determine one or more estimated downlink training bits based on the allocation associated with online constellation learning training and the one or more initial constellations. The WTRU may recreate one or more downlink training bits used by the network device. The WTRU may determine one or more constellation performance metrics for the one or more initial constellations based on the estimated downlink training bits and the recreated downlink training bits. The WTRU may send a report to the network device based on the one or more constellation performance metrics.

### BACKGROUND

For systems using the learned constellation, described herein are methods for the transmitter-side training for online constellation learning.

### SUMMARY

A wireless transmit/receive unit (WTRU) may receive first configuration information from a network device. The first configuration information may comprise one or more initial constellations associated with an AI/ML constellation model. The WTRU may receive second configuration information from the network device. The second configuration information indication may comprise an allocation associated with online constellation learning training. The WTRU may determine one or more estimated downlink training bits based on the allocation associated with online constellation learning training and the one or more initial constellations. The WTRU may determine one or more recreated downlink training bits used by the network device. The WTRU may determine one or more constellation performance metrics for the one or more initial constellations based on the estimated downlink training bits and the recreated downlink training bits. The WTRU may send a report to the network device based on the one or more constellation performance metrics for the one or more initial constellations.

The constellation performance metrics comprise one or more of bit error rate (BER), approximate BER, block error rate (BLER), throughput, and/or or artificial intelligence/machine learning (AI/ML) model loss. The downlink training bits may comprise one or more of pseudo-random data bits and/or data bits. The second configuration information may comprise one or more seed values. The WTRU may recreate the downlink training bits using the one or more seed values and/or a pseudo-random number generator.

The WTRU may recreate the downlink training bits by running a cyclic redundancy check (CRC) on the estimated downlink training bits. The allocation associated with online constellation learning training comprises physical downlink shared channel (PDSCH) resource elements (REs). The second configuration information may further comprise one or more of an uplink resource allocation, one or more grants for transmitting online constellation feedback, and/or online constellation training information. The second configuration information may further comprise one or more of an uplink resource allocation for sending the report. The WTRU may send the report via the uplink resource allocation.

The WTRU may determine training status based on the one or more constellation performance metrics. The training status may indicate whether online constellation learning is complete. The report may comprise an indication of the training status. The WTRU may determine one or more training parameters based on the determined training status. The training parameters may comprise one or more gradients of an end-to-end loss with respect to a downlink channel estimate. The determined training status may indicate whether online constellation learning is complete or not. The report may comprise an indication of the training parameters.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram depicting visualization of the Markov decision process (MDP).

FIG. 3 depicts visualization of transmitted/received legacy 16-quadrature amplitude modulation (QAM) constellation (e.g., four bits per symbol).

FIG. 4 depicts the effects of noise and/or distortion on a received legacy 16-QAM constellation.

FIG. 5 is a diagram depicting visualization of a learned constellation under non-linear phase noise.

FIG. 6 is a diagram depicting an example architecture of an artificial intelligence/machine learning (AI/ML) based constellation.

FIG. 7 is a diagram depicting an example architecture of an artificial intelligence/machine learning (AI/ML) based soft symbol demapper.

FIG. 8 is a diagram depicting transmitter-side training for online constellation learning in downlink.

FIG. 9 is a flowchart depicting wireless transmit receive unit (WTRU) procedures for transmitter-side training for online constellation learning in downlink.

FIG. 10 depicts an orthogonal frequency division multiplexing (OFDM) resource grid with demodulation reference signal (DMRS) and data allocations.

FIG. 11 is a plot of a throughput performance of learned constellation and traditional square-QAM.

FIG. 12A depicts learned constellations for 6 bits per symbol wherein phase noise equals 0°.

FIG. 12B depicts learned constellations for 6 bits per symbol wherein phase noise equals 8°.

FIG. 13 is a diagram depicting WTRU procedures for transmitter-side training for online constellation learning in uplink.

FIG. 14 is a flowchart depicting WTRU procedures for transmitter-side training for online constellation learning in uplink

### DETAILED DESCRIPTION

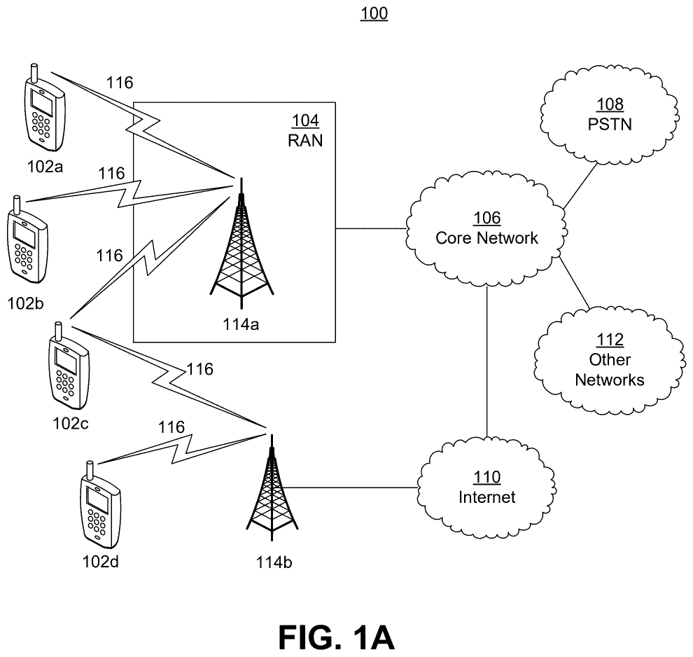

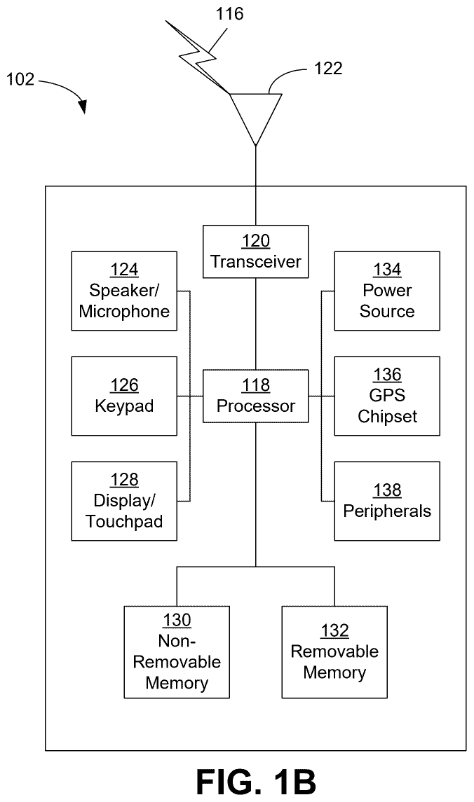

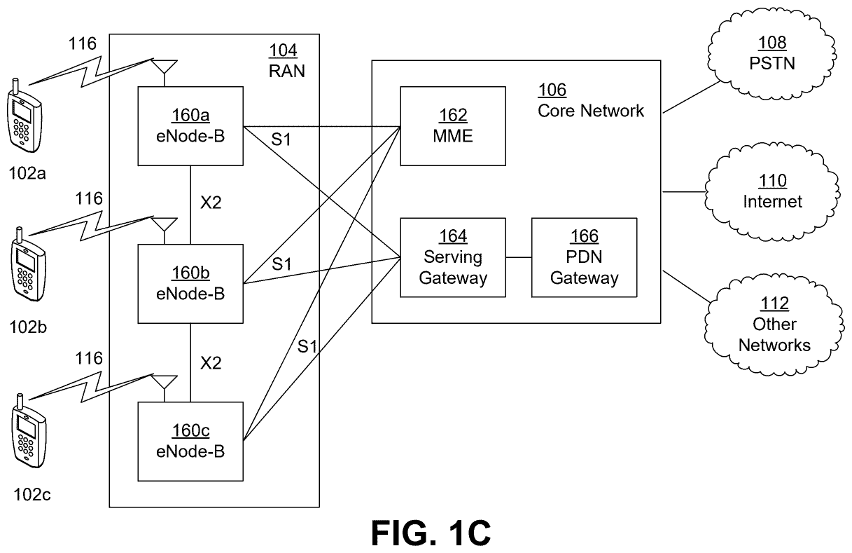

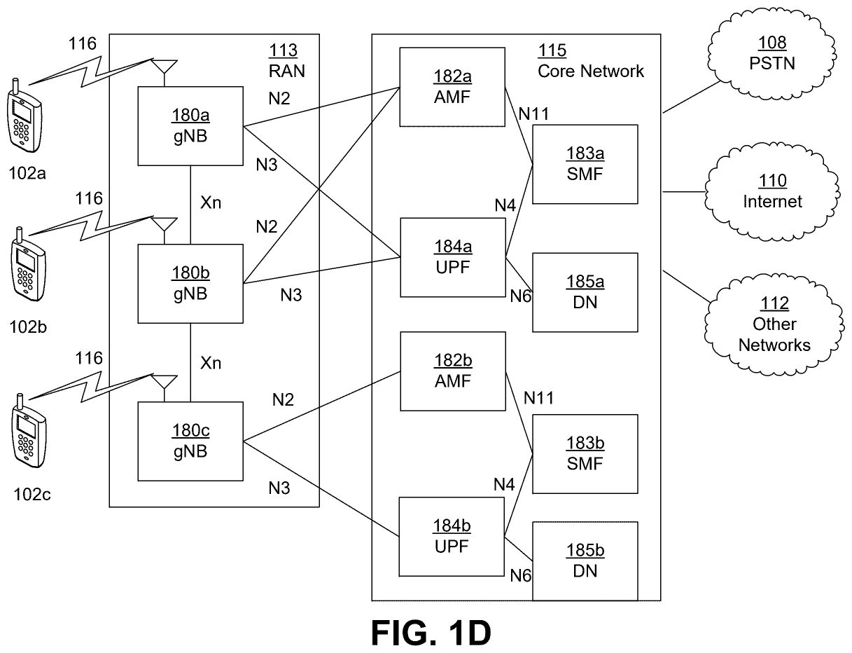

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum.

According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though many of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (‘data’), without being explicitly programmed (‘configuring a set of rules’). ML may be considered as a subset of AI. Different ML paradigms may be envisioned based on the nature of data or feedback available to the learning algorithm. For example, a supervised learning approach may involve learning a function that maps input to an output based on labeled training example. Each training example may be a pair consisting of an input and its corresponding output. In another example, an unsupervised learning approach may involve detecting patterns in the data with no pre-existing labels. In another example, a reinforcement learning approach may involve performing sequence of actions in an environment to maximize the cumulative reward. In some solutions, ML algorithms may use a combination and/or interpolation of the above-mentioned approaches. For example, a semi-supervised learning approach may use a combination of a small amount of labeled data with a large amount of unlabeled data during training. Herein, semi-supervised learning falls between unsupervised learning (with no labeled training data) and supervised learning (with labeled training data).

Deep learning refers to a class of ML algorithms that employ artificial neural networks, specifically, Deep Neural Networks (DNNs), which were loosely inspired from biological systems. The DNNs are a special class of ML models inspired by the human brain wherein the input is linearly transformed and passes through non-linear activation function multiple times. DNNs may consist of multiple layers. Each layer may consist of a linear transformation and/or a given non-linear activation function. The DNNs may be trained using the training data via back-propagation algorithm. Recently, DNNs may have shown state-of-the-art performance in a variety of domains, (e.g., speech, vision, natural language, wireless communication, etc., and/or for various ML settings (e.g., supervised, un-supervised, semi-supervised, etc.)).

Reinforcement learning (RL) is a branch of ML that focuses on decision-making by autonomous agents. An autonomous agent represents a system capable of making independent decisions and responding to its surroundings without direct human intervention. By contrast to supervised and supervised learning, RL agents learn to act and to execute tasks through trial and error, without explicit human guidance. This approach specifically tackles sequential decision-making challenges within dynamic environments.

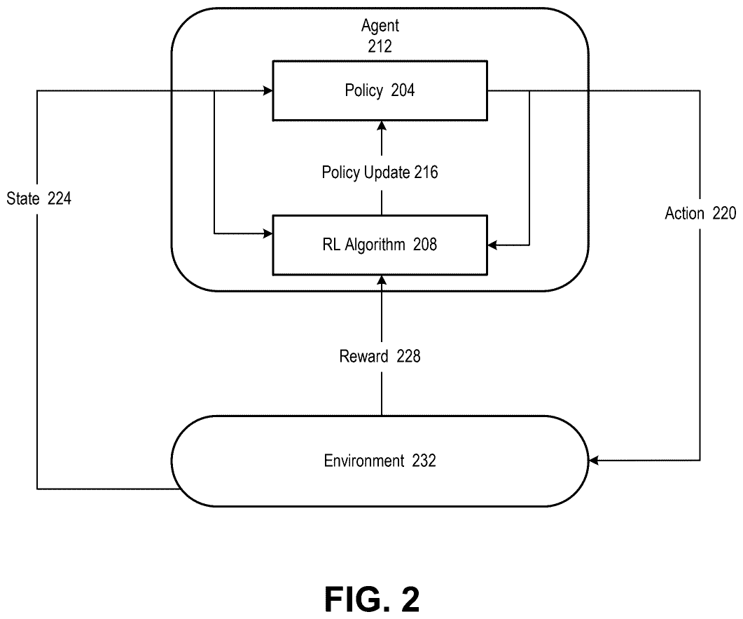

RL may essentially consist of the relationship between an agent, an environment, and a goal. As depicted in FIG. 2, this relationship is formulated in terms of the Markov decision process (MDP). The RL agent may learn about a problem by interacting with its environment. The environment may provide information on its current state. The agent may then use that information to determine which actions to take. The decided action may move the environment from its current state to a new state. If that action obtains a positive reward signal from the surrounding environment, the agent may be encouraged to take that action again when in a similar future state. This process may repeat for every new state thereafter. Over time, the agent may learn from rewards and penalties to take actions within the environment that meet a specified goal. In MDP, state space may refer to all the information provided by an environment's state and/or action space refers to all possible actions the agent may take within a state.

As depicted in FIG. 2, the agent may contain two components: a policy 204 and/or a learning algorithm 208. The policy may be a mapping from the current state to a probability distribution of the actions to be taken. Within an agent 212, a function approximator with tunable parameters and/or a specific approximation model may implement a policy, such as neural networks. At 216, the learning algorithm 208 continuously updates the policy parameters based on the actions 220, states 224, and/or rewards 228. The goal of the learning algorithm 208 is to find an optimal policy that maximizes the expected cumulative long-term reward 228.

Because an RL agent 212 has no manually labeled input data guiding its behavior, it must explore its environment 232, attempting new actions 220 to discover those that receive rewards 228. From these reward 228 signals, the agent 212 may learn to prefer actions 220 for which it was rewarded to maximize its gain. But the agent 212 must continue exploring new states 224 and/or actions 220 as well. In doing so, the agent 212 may use that experience to improve its decision-making. RL algorithms 208 thus require an agent 212 to both exploit knowledge of previously rewarded state-actions and/or explore other state-actions. The agent 212 may not exclusively pursue exploration and/or exploitation. The agent 212 may continuously try new actions 220 while also preferring single (or chains of) actions 220 that produce the largest cumulative reward 228.

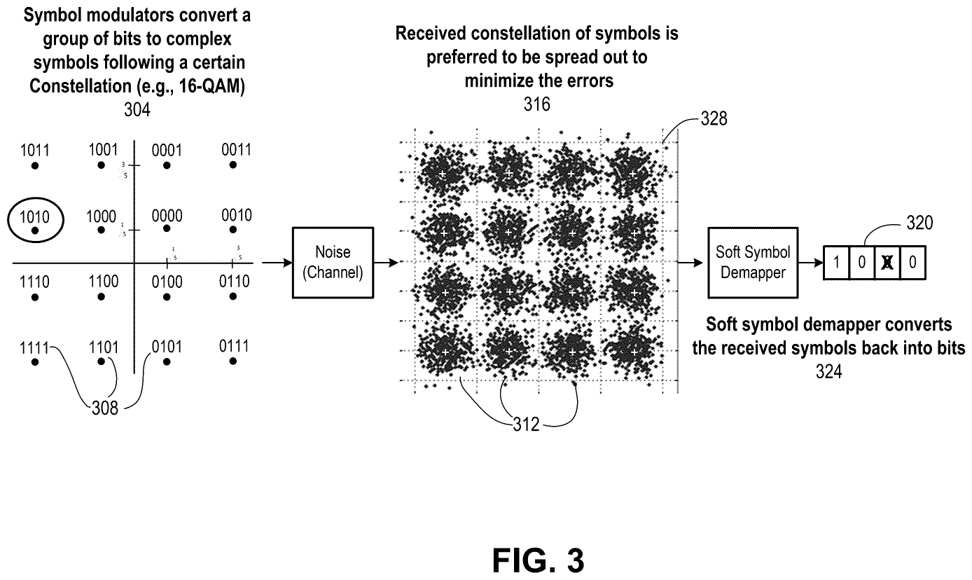

Symbol modulation and/or symbol demodulation are among the fundamental blocks of the physical (PHY) layer of wireless communications. As depicted in FIG. 3, the symbol modulators 304 may convert a group of bits 308 to complex symbols that represent the in-phase and/or quadrature components of the baseband signal. The symbol demodulators 328, however, may convert the received baseband complex signals 312 in the received constellation 316 to group of soft bits 320, (e.g., log likelihood ratios (LLRs)), that are fed into the channel decoder 324. The number of bits carried within a symbol may depend on the modulation order of the modulation scheme. The typical legacy symbol modulation schemes may include modulation orders M, which carry k=log₂ M bits per symbol, 4-quadrature amplitude modulation (QAM), 16-QAM, 64-QAM, 256-QAM, and/or 1024-QAM. These legacy constellation shapes may be based on a square grid structure 308 which is known to be sub-optimal. In the current 3GPP specifications, the constellations per modulation order and/or the corresponding modulation and coding scheme (MCS) tables may be pre-defined.

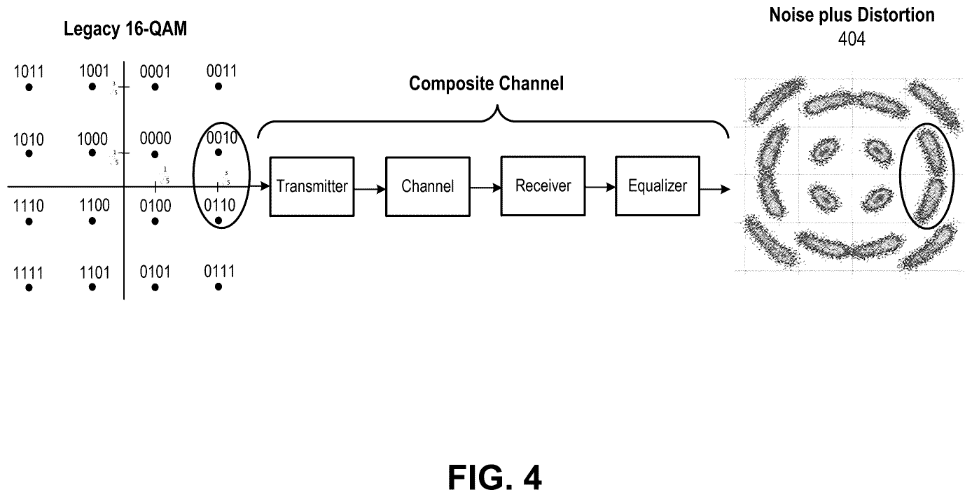

As depicted in FIG. 4, the impact of transmitter and/or receiver impairments and/or imperfect equalization may cause a distortion 404 that has a more complicated effect on the received symbols. Some points in the constellation may become more error prone than others.

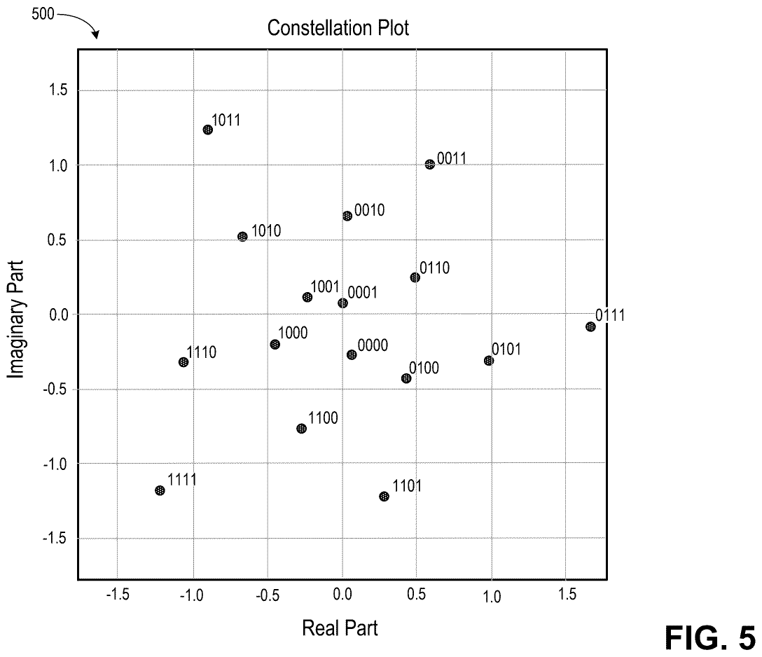

The performance of wireless communication systems may depend on the choice of constellations. As described above, the conventional square QAM constellations may not be optimal. The optimal constellation design may depend on hardware impairments and/or may vary over time and/or frequency. The learned constellations, (e.g., through techniques like end-to-end learning), may improve the bit error rate and/or throughput performance in the presence of various hardware impairments. The constellation learning may compromise between performance, efficiency, and/or hardware requirements. FIG. 5 depicts a diagram 500 of a learned constellation with modulation order 16 (e.g., 4 bits per symbol) under the non-linear impairment and/or phase noise. The end-to-end learning schemes may dynamically learn the mapper (bits to symbols) and demapper (received symbols to soft bits).

The traditional square QAM constellation has been widely used in the communication systems, including 5G NR, due to its simple structure. For example, quadrature phase-shift keying (QPSK), 16-QAM, 64-QAM, 256-QAM and 1024-QAM are the square QAM constellations adopted in 3GPP. However, the square QAM constellations may be sub-optimal, even in the AWGN channel. The optimal constellation may depend on radio and/or hardware impairments (e.g., phase noise, in-phase/quadrature (I/Q) imbalance, carrier frequency offset, and/or power amplifier (PA) nonlinearities), channel conditions (e.g., indoor and/or outdoor), channel quality (e.g., signal to noise ratio (SNR)), etc. AI/ML may be utilized for learning the optimal constellation. However, there is no mechanism in place for sharing the new (e.g., learned) constellations between the transmitter and receiver (e.g., from network (NW) to WTRU in downlink, from WTRU to NW in uplink).

The constellations learned via offline constellation learning through the datasets may not be suitable for all experienced channel conditions and/or hardware and/or radio impairments. Online (in situ) learning may alleviate this. However, there is no mechanism in place that enables online constellation learning. Methods to request, admit, control, and/or terminate the online constellation learning and/or monitor the performance of learned constellation may be required.

A solution may include transmitter-side training for online constellation learning in downlink. Online constellation learning in downlink may improve the end-to-end system performance (e.g., bit error rate (BER), approximate BER, BLER, and/or throughput, etc.), by adapting to the hardware and/or radio impairments and/or dynamic channel conditions. The proposed solution may present the steps and/or procedures enabling online constellation learning in downlink through transmitter-side training. The proposed solution may first enable configuring a WTRU as the receiver with a set of initial constellations (e.g., square QAM and/or non-square QAM). Afterwards, the NW as the transmitter may use the downlink training bits (e.g., data bits, pseudo-random data bits) to create the modulated symbols, which may be transmitted over-the-air to the receiver. By using the downlink training bits, the WTRU may calculate the gradients and/or learned constellation performance metrics (e.g., AI/ML model loss, BER, approximate BER, BLER, and/or throughput, etc.). The WTRU may then report one or more constellation performance metrics to the transmitter as online constellation learning feedback. The transmitter may train the constellation through online constellation learning feedback.

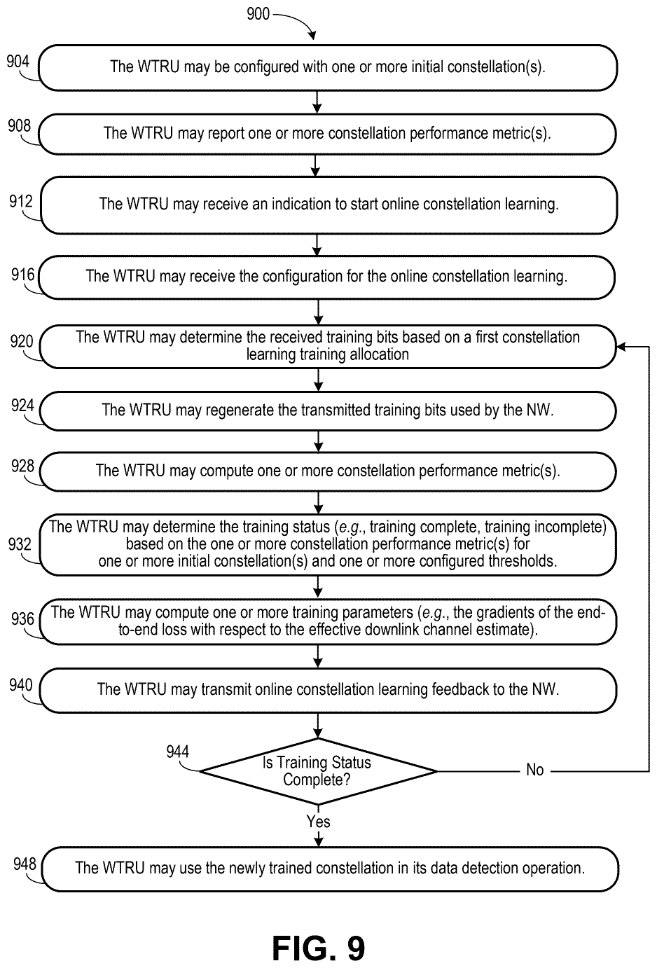

The procedures for enabling the transmitter-side training for online constellation learning in downlink are detailed below and summarized in FIG. 9. The NW may refer to any node in the network (e.g., gNB), another WTRU (e.g., sidelink and/or WTRU-to-WTRU direct communication, etc.). The WTRU may be configured (e.g., through RRC signaling) with one or more initial constellation(s). The WTRU may be configured with an initial constellation diagram for each modulation order. The WTRU may be configured with multiple initial constellation diagrams (e.g., a single constellation per sub-band, per precoding resource block group, RB set, or per layer). For example, the first sub-band may be configured with a constellation with 16 symbols (e.g., 4 bits per symbol). The second sub-band may be configured with a constellation with 64 symbols (e.g., 6 bits per symbol). The configured initial constellation diagrams may include, but may not limited to a previously trained and/or learned constellation under a similar condition (e.g. channel conditions, hardware impairments); a trained and/or learned constellation during online constellation learning iterations; a square QAM constellation for the first iteration of online constellation learning.

The WTRU may be configured (e.g. by RRC signaling) to report one or more constellation performance metrics. The constellation performance metrics may include BER, approximate BER, BLER, and/or throughput, AI/ML model loss, etc. The WTRU may determine one or more constellation performance metrics for one or more configured constellation(s). The WTRU reports one or more of the determined constellation performance metrics to the NW (e.g., through uplink control information (UCI) or medium access control (MAC) control element (CE)).

The WTRU may receive a command and/or message to start online constellation learning. Triggers to initiate constellation learning may include, but not be limited to: the WTRU is configured to use AI/ML for constellation learning (e.g., for a first time). The WTRU (or the NW) may detect a need to start constellation learning. Examples may include, but not be limited to: AI/ML models drift detection mechanisms at the WTRU and/or the NW may indicate that the AI/ML models have drifted and/or are drifting. The WTRU may enter a geographic region or a cell (e.g., a new cell ID and/or a new registration area) for which the constellation has not been previously trained. The WTRU may compare global positioning system (GPS) coordinates to measure distance to previously trained regions. If distance is above a threshold provided by the NW, the WTRU may signal the NW indicating that the threshold is exceeded, and possibly the distance and/or the current location. The training for the online constellation learning may be periodic, aperiodic, or semi-persistent.

The WTRU may receive the configuration for the online constellation learning in downlink, which may contain online constellation learning training allocations. The WTRU may receive physical downlink shared channel (PDSCH) resource elements (REs) carrying the symbols modulated by downlink training bits during online constellation learning training allocations. The downlink training bits may include, but may not limited to pseudo-random data bits generated through a seed and/or data bits. The uplink resource allocation or grants for transmitting the online constellation learning feedback (e.g., gradients and/or learned constellation performance metrics).

The WTRU may learn a constellation in the following configurations: for each modulation order greater than 2 bits per symbol through the configured SNRₘᵢₙ and SNRₘₐₓ for each modulation order; for each modulation order and code rate (e.g., per MCS) through the configured of SNRₘᵢₙ and/or SNRₘₐₓ for each MCS (e.g., learning the constellations for a range of SNR in a given MCS); and/or for each combination of MCS (with its associated SNR range) and hardware/radio impairment class through the configured of SNRₘᵢₙ and/or SNRₘₐₓ for each MCS and partitioned channel bandwidth (BW) (e.g., sub-band) with a common class of hardware/radio impairments.

Training related information, which includes, but may not be limited to: seed(s) to recreate the downlink training bits used by the NW; a set of code rate for forward error correction (FEC) (e.g., low-density parity check (LDPC)). A set of code rates may include a code rate for each configured constellation and/or a fixed code rate for all configured constellations.

Training related information may include AI/ML model loss function. The AI/ML model loss function may be different for each configured learned constellation. The WTRU may compute the estimated downlink training bits by processing the received allocated transmission to produce a multi-bit resolution estimate of the downlink training bits, (e.g., the recovered downlink training bits may be soft bits such as LLRs). The estimated downlink training bits may be computed before FEC decoder, where they are referred to as coded bits and/or raw bits. The estimated downlink training bits may be computed after FEC where they are referred to as decoded bits. The WTRU may use a loss function taking as input the recreated transmitted downlink training bits and the estimated downlink training bits to compute the end-to-end loss through the recreated downlink training bits and the estimated downlink training bits. The WTRU may use the gradients with respect to the end-to-end loss to train a single (or multiple) AI/ML model(s) for any receiver functions (e.g., a combination of channel estimator, equalizer, demodulator, and/or channel decoder). The examples of end-to-end loss functions may include, mean square error (MSE), binary cross entropy (BCE), or approximations of decoded BER, coded BER, BLER, and/or throughput, etc.

Moreover, training related information may include a set of thresholds to monitor the training progress of each configured learned constellation and/or a set of learned constellation performance metrics (e.g., BER, uncoded BER, approximate BER, BLER, and/or throughput, and/or I/ML model loss, etc.). The WTRU may report the set of learned constellation performance metrics to the NW during the online constellation learning iterations.

The WTRU may determine the estimated downlink training bits based on a first constellation learning training allocation. The WTRU may recreate the transmitted downlink training bits used by the NW. For example, the WTRU may employ a pseudo-random bit generator with the same seeds and/or number generator used by the NW if the NW generates downlink training bits via the pseudo-random data bits. The WTRU may utilize the hard decision applied to the estimated downlink training bits as downlink training bits when the CRC check succeeds (e.g., if the NW uses data bits as downlink training bits).

The WTRU may compute one or more constellation performance metric(s) for one or more initial constellation(s) based on the recreated downlink training bits and the estimated downlink training bits. The WTRU may determine the training status (e.g., training complete, training incomplete) based on the one or more constellation performance metric(s) for one or more initial constellation(s) and/or one or more configured thresholds.

The WTRU may compute one or more training parameters (e.g., the gradients of the end-to-end loss with respect to the effective (e.g., precoded) downlink channel estimate), based on the training status (e.g., if training status is training incomplete). The WTRU may use the differentiation chain rule to compute the gradients. The WTRU may use the effective downlink channel estimate when computing the gradients. The WTRU may transmit online constellation learning feedback to the NW, (e.g., through UCI and/or MAC-CE). The online constellation learning feedback may include one or more of: the computed one or more constellation performance metric(s) for one or more initial constellation(s), the one or more training parameters, and/or the training status. The WTRU may use the newly trained constellation in, e.g., its data detection operation.

On the NW side, the NW may configure the WTRU for the online constellation learning based on a received one or more constellation performance metric(s) for one or more initial constellation(s). The NW may train one or more second constellation(s) based on the received online constellation learning feedback from the WTRU. For example, the NW may receive and/or utilize training parameters (e.g., gradients) to train one or more second constellation(s), e.g., via supervised learning. The NW may use the received gradients with respect to the effective (e.g., precoded) downlink channel, and apply the differentiation chain rule for computing the gradients with respect to the trainable second constellation. The NW may train the second constellation by using the gradients with respect to the initial constellation using supervised learning. The NW may utilize the one or more constellation performance metrics to train one or more second constellation(s) using RL. The RL agent at the NW may apply a perturbation vector to the constellations representing the action of RL agent. The perturbation vector may include the perturbations for each symbol point (e.g., 2M values for modulation QAM (M-QAM)). The NW may configure the WTRU with the one or more second constellation(s), (e.g., through RRC signaling).

A solution may include transmitter-side training for online constellation learning in uplink. Online constellation learning in uplink improves the end-to-end system performance (e.g., BER, approximate BER, BLER, and/or throughput, etc.), by adapting to the hardware and/or radio impairments and dynamic channel conditions. The proposed solution presents the steps and/or procedures enabling online constellation learning in uplink through transmitter-side training. The proposed solution may first enable configuring a WTRU as the transmitter with a set of initial constellations (e.g., square QAM, non-square QAM). Afterwards, the WTRU may use the uplink training bits (e.g., data bits, pseudo-random data bits) to create the modulated symbols, which are transmitted over-the-air to the NW. By using the uplink training bits, the NW may calculate the gradients and/or learned constellation performance metrics (e.g., AI/ML model loss, BER, approximate BER, BLER, and/or throughput, etc.), then sends one or more of them to the WTRU as online constellation learning feedback. The WTRU may train the constellation through online constellation learning feedback and report the learned constellation to the NW.

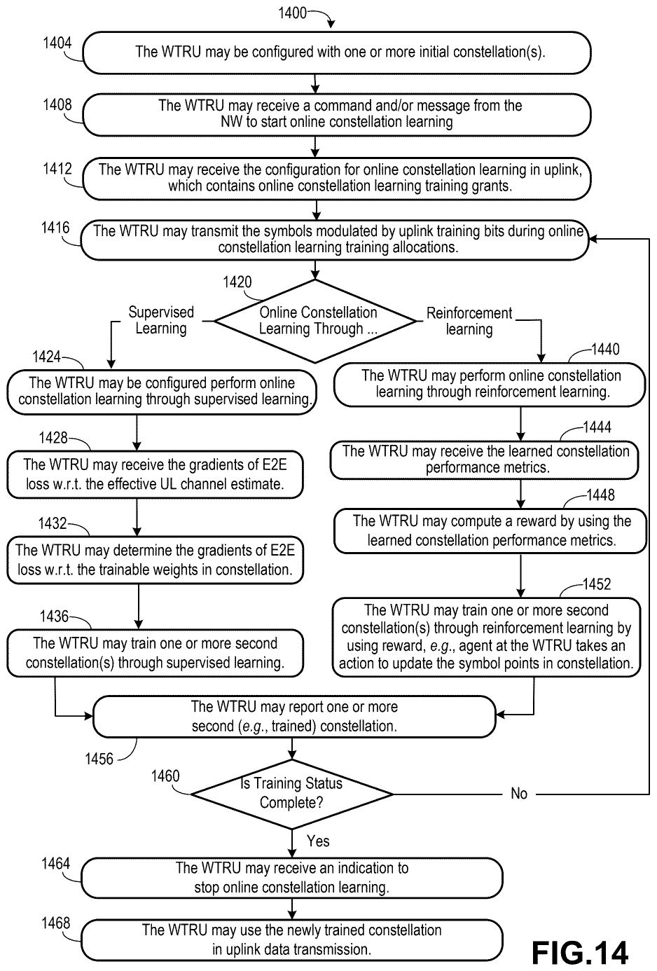

The procedures for enabling the transmitter-side training for online constellation learning in uplink are detailed below and summarized in FIG. 14. FIG. 14 is a flowchart depicting WTRU procedures for transmitter-side training for online constellation learning in uplink. The NW may refer to any node in the network (e.g., gNB), another WTRU (e.g., sidelink and/or WTRU-to-WTRU direct communication), etc.

The WTRU may be configured (e.g., through RRC signaling) with one or more initial constellation(s). The WTRU may be configured with an initial constellation diagram for each modulation order. The WTRU may be configured with multiple initial constellation diagrams, e.g., a single constellation diagram per sub-band, per precoding resource block group, resource block (RB) set, or per layer. For example, the first sub-band may be configured with a constellation with 16 symbols (e.g., 4 bits per symbol). The second sub-band may be configured with a constellation with 64 symbols (e.g., 6 bits per symbol). The configured initial constellation diagrams may include, but may not limited to: a previously trained and/or learned constellation under a similar condition (e.g., channel conditions and/or hardware impairments); a trained and/or learned constellation during online constellation learning iterations; and/or a square QAM constellation for the first iteration of online constellation learning.

The WTRU may receive a command and/or message to start online constellation learning. Triggers to initiate constellation learning may include, but may not be limited to: the WTRU may use AI/ML for constellation learning (e.g., for a first time). The WTRU (or the NW) may detect a need to start constellation learning. Examples include, but may not be limited to: AI/ML models drift detection mechanisms at the WTRU and/or the NW indicate that the AI/ML models have drifted and/or are drifting. The WTRU may enter a geographic region or a cell (e.g., a new cell ID and/or a new registration area) for which the constellation may have not previously trained. Examples include, but may not be limited to: the WTRU may compare GPS coordinates to measure distance to previously trained regions. If distance is above a threshold provided by the NW, the WTRU may signal the NW indicating the threshold is exceeded, and/or possibly the distance and/or the current location. The training for the online constellation learning may be periodic, aperiodic, or semi-persistent.

The WTRU may receive the configuration for the online constellation learning in uplink. The configuration may contain the following information: online constellation learning training allocations; for example, online constellation learning training allocations may include a set of PUSCH REs on which the WTRU transmits the symbols modulated by uplink training bits. The uplink training bits may include, but may not be limited to pseudo-random data bits generated through a seed and/or data bits.

The downlink resource allocation to receive the online constellation learning feedback (e.g., gradients and/or learned constellation performance metrics). The WTRU may receive the gradients of the end-to-end loss with respect to the effective uplink channel estimate on the downlink resources (e.g., signal by downlink control information (DCI) and/or MAC-CE).

For example, the WTRU may receive one or more constellation performance metric(s) for one or more configured constellation(s) on downlink resources (e.g., signaled by DCI or MAC-CE). The constellation performance metrics may include BER, approximate BER, BLER, and/or throughput, and/or AI/ML model loss, etc.

The WTRU may learn a constellation in the following configurations: for each modulation order greater than 2 bits/symbol through the configured SNRₘᵢₙ and/or SNRₘₐₓ for each modulation order; for each modulation order and code rate (e.g., per MCS) through the configured of SNRₘᵢₙ and SNRₘₐₓ for each MCS (e.g., learning the constellations for a range of SNR in a given MCS); for each combination of MCS (with its associated SNR range) and hardware/radio impairment class through the configured of SNRₘᵢₙ and SNRₘₐₓ for each MCS and partitioned channel BW (e.g., sub-band) with a common class of hardware/radio impairments.

Training related information may include but may not be limited to: seed(s) to generate the uplink training bits at the WTRU; seed(s) to generate pseudo-random perturbations for creating perturbations for groups of REs; configurations about which group of REs may be associated with which perturbation; and/or a set of code rate for FEC (e.g., LDPC). A set of code rates may include a code rate for each configured constellation and/or a fixed code rate for all configured constellations.

The WTRU may perform online constellation learning through supervised learning. The WTRU may receive the gradients of the end-to-end loss with respect to the effective uplink channel estimate computed by the NW as online constellation learning feedback. The WTRU may determine the gradients of end-to-end loss with respect to the trainable weights in the constellation by using the online constellation learning feedback. The WTRU may train one or more second constellation(s) through supervised learning by using the gradients of end-to-end loss with respect to the trainable weights. The WTRU may use a learning algorithm, e.g., stochastic gradient decent (SGD), adaptive moment estimation (ADAM), and/or root mean square propagation (RMSProp).

Additionally or alternatively, the WTRU may perform online constellation learning through reinforcement learning. The WTRU may receive the learned constellation performance metrics computed by the NW as online constellation learning feedback.

The WTRU may compute a reward by using the received learned constellation performance metrics. The reward may be a vector constructed from the received learned constellation performance metrics associated with each perturbation (e.g., mean AI/ML model loss over all REs with the same perturbation). The WTRU may train one or more second constellation(s) through reinforcement learning by using reward, e.g., the reinforcement learning agent at the WTRU may take an action to update the symbol points in the learned constellation. For example, the reinforcement learning agent at the WTRU may apply a perturbation vector to the constellations representing the action of reinforcement learning agent. The perturbation vector may include the perturbations for each symbol point in the learned constellation (e.g., 2M values for M-QAM constellation). The WTRU may report one or more second (e.g., trained) constellation(s) to the NW. The reporting may be transmitted as UCI on PUCCH/PUSCH, as MAC-CE, or as RRC signaling. The WTRU may receive an indication to stop online constellation learning (e.g., training is complete).

Online constellation learning in downlink may improve the end-to-end system performance (e.g., BER, approximate BER, BLER, and/or throughput, etc.), by adapting to the hardware and/or radio impairments and dynamic channel conditions. The proposed solution may present the steps and/or procedures enabling online constellation learning in downlink through transmitter-side training. The proposed solution may first enable configuring a WTRU as the receiver with a set of initial constellations (e.g., square QAM and/or non-square QAM). Afterwards, the NW as the transmitter uses the downlink training bits (e.g., data bits, pseudo-random data bits) to create the modulated symbols, which are transmitted over-the-air to the receiver. By using the downlink training bits, the WTRU may calculate the gradients and/or learned constellation performance metrics (e.g., AI/ML model loss, BER, approximate BER, BLER, and/or throughput, etc.), then reports one or more of them to the transmitter as online constellation learning feedback. The transmitter may train the constellation through online constellation learning feedback.

The constellation learning may be based on two AI/ML models, one residing at the NW and one residing at the WTRU. The AI/ML model residing at the NW may be referred to as a constellation (or, e.g., a constellation mapper), maps the information bits at the NW to complex constellation symbols to be transmitted to the WTRU through the DL transmission chain (resource mapping, precoding, etc.). The AI/ML model residing at the WTRU, referred to as the soft symbol demapper, may map the equalized complex symbols from the NW to LLRs (or, e.g., hard bits). The equalized complex symbols may then convert back to information bits. The stages of the AI/ML process may include, but not be limited to the following steps:

The process may begin with application: the stage that involves online constellation learning. At the input data stage, the constellation may associate with downlink training bits. The soft symbol demapper may be associated with equalized complex symbols at the WTRU. The estimated noise power at the WTRU may also be a part of the AI/ML model input.

At the preprocessing stage, the constellation may associate with an optional preprocessing applying channel encoding to the downlink training bits. The soft symbol demapper: may associate with concatenation of the real and/or imaginary parts of the complex symbols to obtain the real-valued input to the AI/ML model.

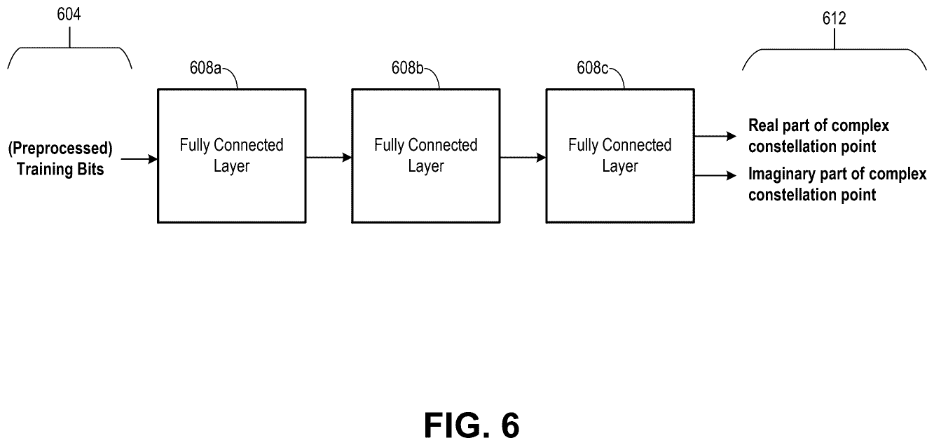

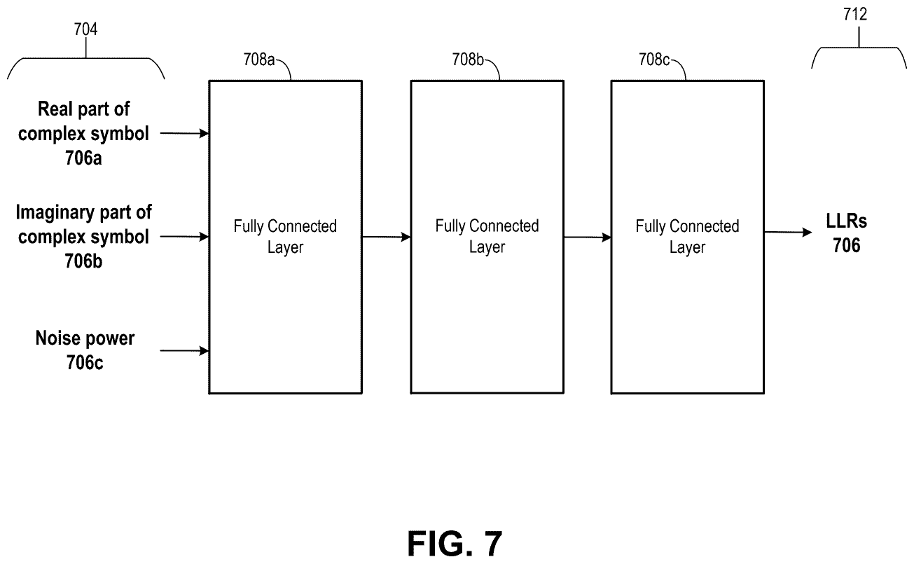

At the stage of the application of the AI/ML model, the constellation may be associated with an example AI/ML model for the constellation mapper as depicted in FIG. 6. The example AI/ML model may be comprised of an input layer, multiple fully connected layers, and/or an output layer. The soft symbol demapper may be associated with an example AI/ML model as depicted in FIG. 7. The example AI/ML model may be comprised of an input layer 704, multiple fully connected layers 708a, 708b, 708c, and/or an output layer 712.

During the output data phase, assuming that the constellation to be learned has an order of M, e.g., M constellation points, the input 604 to the AI/ML model for the constellation mapper may be a codeword with log 2 Mbits and the output of the AI/ML model for the constellation mapper are the real and/or imaginary parts 612 of the constellation point associated to the input codeword. Assuming that the constellation to be learned has an order of M, e.g., M constellation points, the inputs to the AI/ML model for the soft symbol demapper are the real 706a and/or imaginary 706b parts of the received equalized symbol at the WTRU. The inputs 704 may also be an estimate of the noise power 706c at the WTRU and/or the output 712 of the AI/ML model for the soft symbol demapper are the log₂ M LLRs 716 associated to the log₂ M bits of the original codeword input to the constellation mapper.

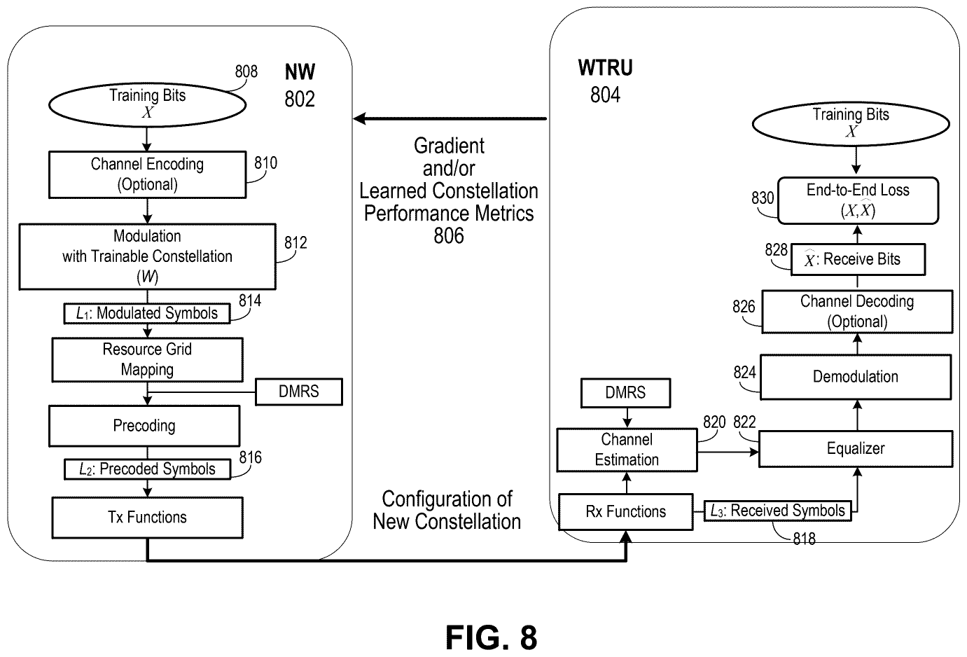

In the training phase, the NW may send the downlink training bits for the online constellation learning as shown in FIG. 8. FIG. 8 is a diagram depicting transmitter-side training for online constellation learning in downlink. The training of the constellation may be performed at the transmitter-side 802 (e.g., NW-side) by using online constellation learning feedback. As explained herein, the training may be performed through either supervised learning and/or reinforcement learning.

In supervised learning, the transmission and/or reception blocks involved in the end-to-end transmission (at the NW 802 and/or the WTRU 804, respectively) may be differentiable or approximated as such. At 806, the WTRU 804 and/or the NW 802 may compute the gradients of end-to-end loss with respect to the trainable parameters in the constellation. The NW 802 may employ a modulator with trainable and/or learned constellation. The trainable parameters in the constellation may be denoted by W as shown at 812. The NW 802 may modulate the downlink training bits X 808 (or coded downlink training bits 808 through channel encoder 810), denoted by L₁, as shown at 814. The NW 802 may transmit the precoded symbols denoted by L₂ as shown at 816. The WTRU 804 may extract the received data symbols denoted by L₃ as shown at 818. After performing the channel estimation 820, equalization 822, demodulation 824, and/or channel decoding (optional) 826, the WTRU 804 may obtain the received bits denoted by \hat{X} at 828.

The WTRU 804 may compute the end-to-end loss by using X and/or \hat{X}, denoted by Loss (X, [symbol] at 830. The WTRU 804 may compute and/or report the learned constellation performance metrics (e.g., uncoded BER, approximate BER, BLER, and/or throughput, and/or AI/ML model loss, etc.). By using the differentiation chain rule and/or assuming all transmission/reception blocks are differentiable (or can be approximated), the WTRU 804 and/or the NW 802 may compute the gradients of end-to-end loss with respect to the trainable weights in the constellation (e.g., ∂Loss(X,\hat{X})/∂w). By using the differentiation chain rule, the gradients of end-to-end loss with respect to the trainable parameters 812 in the constellation may be expanded as:

$$\frac{\partial Loss ( X , \hat{X} )}{\partial W} = \frac{\partial Loss ( X , \hat{X} )}{\partial \hat{X}} \times \frac{\partial \hat{X}}{\partial {L}_{3}} \times \frac{\partial {L}_{3}}{\partial {L}_{2}} \times \frac{\partial {L}_{2}}{\partial {L}_{1}} \times \frac{\partial {L}_{1}}{\partial W}$$

The WTRU 804 may compute the gradients

$$\frac{\partial Loss ( X , \hat{X} )}{\partial \hat{X}} \times \frac{\partial \hat{X}}{\partial {L}_{3}} \times \frac{\partial {L}_{3}}{\partial {L}_{2}} ,$$

and report it to the NW 802. The NW 802 may compute the gradients of end-to-end loss with respect to the trainable parameters 812 in the constellation (e.g., ∂Loss(X,\hat{X})/∂W) by the received gradients and/or computed gradients

$$\frac{\partial {L}_{2}}{\partial {L}_{1}} \times \frac{\partial {L}_{1}}{\partial W} .$$

The NW 802 may train the parameters 812 through supervised learning. The NW 802 may use a learning algorithm, e.g., SGD, ADAM, RMSProp.

In reinforcement learning, the WTRU may compute the learned constellation performance metrics (e.g., uncoded BER, approximate BER, BLER, and/or throughput, and/or AI/ML model loss, etc.). The WTRU may report the learned constellation performance metrics.

The NW may train the constellation using reinforcement learning. For example, a reinforcement learning agent may be located at the NW. Symbol points in the constellation and/or other metrics (such as SNR/SINR of the channel) may represent the state. The NW may calculate the reward by using the learned constellation performance metrics. For example, the reward may be a vector constructed from a metric associated with each perturbation, (e.g., mean BCE taken over all REs with the same perturbation). An agent may take an action to update the symbol points in the learned constellation. The NW may take an action (e.g., the agent at the NW may take an action) to update the symbol points in the learned constellation. For example, the agent may apply a perturbation vector to the constellations representing the action of reinforcement learning agent. The perturbation vector may include the perturbations for each symbol point in the learned constellation. The decided action by the agent moves the environment from its current state to a new state.

The NW may initiate the WTRU capability exchange process by sending the UECapabilityEnquiry RRC message to the WTRU. This message may request specific information regarding the WTRU's capabilities. The NW may include parameters in this message to specify which capabilities it has interest. The NW may specify parameters related to WTRU's capability in supporting online constellation learning in downlink in UECapabilityEnquiry message (e.g., the capability of transmitting online constellation learning feedback).

Upon receiving the UECapabilityEnquiry RRC message, the WTRU may respond with the UECapabilityInformation RRC message accordingly. This message may include detailed information about the WTRU's capabilities. During the WTRU capability exchange process between the WTRU and/or the NW, the following key parameters related to the AI/ML functions include, but not be limited to: an indicator of whether online constellation learning in downlink is supported or not; an indicator of whether receiving symbols modulated through one or more learned constellations (e.g., non-square QAM) is supported or not; an indicator of whether the customization of demodulator(s) (e.g., soft symbol demapper(s)) based on the configured learned constellation(s) is supported or not; an indicator of whether computing learned constellation performance metrics (e.g., BER, approximate BER, BLER, and/or throughput, AI/ML model loss, etc.) is supported or not; and an indicator of whether reporting learned constellation performance metrics (e.g., BER, approximate BER, BLER, and/or throughput, AI/ML model loss, etc.) is supported or not.

The message may include an indicator of whether recreating the downlink training bits is supported or not. For example, the WTRU may recreate the downlink training bits through a pseudo-random bit generator with the same seeds used by the NW if the NW generates downlink training bits via the pseudo-random data bits. The WTRU may recreate the downlink training bits through the estimated downlink training bits when the CRC check succeeds if the NW generates downlink training bits via the data bits.

The message may further include an indicator of whether computing the gradients of the end-to-end loss with respect to the effective (e.g., precoded) downlink channel is supported or not; and indicator of whether reporting the gradients of the end-to-end loss with respect to the effective (e.g., precoded) downlink channel is supported or not; an indicator of whether reporting online constellation learning feedback is supported or not; and/or an indicator of whether sending “training complete” message to the NW is supported or not.

Through WTRU capability exchange process, the NW may know the WTRU's capability to support the transmitter-side training of constellation learning in downlink and use the learned constellation. For a WTRU capable of supporting such a function and/or feature, the key parameters should be configured by the NW, which may include, but not limited to: the configuration for one or more initial constellation(s). The WTRU may be configured with an initial constellation diagram for each modulation order. The WTRU may be configured with multiple initial constellation diagrams, (e.g., a single constellation per sub-band, per precoding resource block group, or RB set). For example, the first sub-band may be configured with a constellation with 16 symbols (e.g., 4 bits per symbol), while the second sub-band may be configured with a constellation with 64 symbols (e.g., 6 bits per symbol). The configured initial constellation diagrams may include, but may not be limited to: a previously trained and/or learned constellation under a similar condition (e.g. channel conditions, hardware impairments); a trained and/or learned constellation during online constellation learning iterations; and a square QAM constellation for the first iteration of online constellation learning.

The configuration for reporting the learned constellation performance metrics may include but not be limited to the reporting periodicity (e.g., periodic, semi-persistent, and/or aperiodic) and/or the reporting quantity (e.g., BER, approximate BER, BLER, throughput, and/or AI/ML model loss, etc.). The configuration for online constellation learning training allocations may include, but not be limited to the WTRU may estimate downlink training bits through online constellation learning training allocations. The downlink training bits may include, but not limited to pseudo-random data bits generated through a seed. For example, the WTRU may regenerate the downlink training bits through a pseudo-random bit generator with the configured seeds and/or data bits. The WTRU may recreate the downlink training bits through the estimated downlink training bits when the CRC check of the downlink data bits (through PDSCH) succeeds. Seeds may be used to initialize a pseudo-random data bits generator to generate the downlink training bits at the NW. Downlink training bits may further include the code rate of FEC code (e.g., LDPC).

The configuration for learning a constellation may occur for each modulation order greater than 2 bits/symbol through the configured SNRₘᵢₙ and/or SNRₘₐₓ for each modulation order; for each modulation order and code rate (e.g., per MCS) through the configured of SNRₘᵢₙ and SNRₘₐₓ for each MCS; and/or for each combination of MCS (with its associated SNR range) and/or hardware and/or radio impairment class through the configured of SNRₘᵢₙ and SNRₘₐₓ for each MCS and partitioned channel BW having a common class of hardware and/or radio impairments.

Key parameters may include the uplink resource allocations for transmitting the online constellation learning feedback (e.g., gradients and/or learned constellation performance metrics). The training related information, may include, but not be limited to: the learning algorithm, learning rates, regularization parameters, etc.; the total number of training sessions; the end-to-end loss function (e.g., binary cross entropy, mean square error); the thresholds to monitor the training progress of each configured learned constellation; and/or the learned constellation performance metrics (e.g., uncoded BER, approximate BER, BLER, and/or throughput, and/or AI/ML model loss).

The following signals may be defined to enable the WTRU (or the NW) to detect the need for initiating online constellation learning, and/or to enable the WTRU to use the learned constellation(s): a request to report its hardware impairment information (e.g., phase noise, I/Q imbalance, carrier frequency offset, PA nonlinearities) transmitted from the NW to the WTRU (e.g., through RRC signaling); a report with the hardware impairment information transmitted from the WTRU to the NW (e.g., through RRC signaling); training activation for the online constellation learning transmitted from the NW to the WTRU (e.g., through DCI and/or MAC-CE); configuration for online constellation learning training allocations transmitted from the NW to the WTRU; learned constellation performance metrics transmitted from the WTRU to the NW (e.g., through UCI and/or MAC-CE); gradients of the end-to-end loss with respect to the effective (e.g., precoded) downlink channel transmitted from the WTRU to the NW; online constellation learning feedback transmitted from the WTRU to the NW; an indication that training may be complete transmitted from the WTRU to the NW; and/or an indication that training may be complete transmitted from the NW to the WTRU.

A solution may include transmitter-side training for online constellation learning in downlink. Online constellation learning in downlink may improve the end-to-end system performance (e.g., BER, approximate BER, BLER, and/or throughput, etc.), by adapting to the hardware and/or radio impairments and/or dynamic channel conditions. The proposed solution may present the steps and/or procedures enabling online constellation learning in downlink through transmitter-side training. The proposed solution may first enable configuring a WTRU as the receiver with a set of initial constellations (e.g., square QAM and/or non-square QAM). Afterwards, the NW as the transmitter may use the downlink training bits (e.g., data bits, pseudo-random data bits) to create the modulated symbols, which may be transmitted over-the-air to the receiver. By using the downlink training bits, the WTRU may calculate the gradients and/or learned constellation performance metrics (e.g., AI/ML model loss, BER, approximate BER, BLER, and/or throughput, etc.). The WTRU may then report one or more constellation performance metrics to the transmitter as online constellation learning feedback. The transmitter may train the constellation through online constellation learning feedback.

The procedures for enabling the transmitter-side training for online constellation learning in downlink are detailed below and summarized in FIG. 9. FIG. 9 is a flowchart 900 depicting WTRU procedures for transmitter-side training for online constellation learning in downlink. The NW may refer to any node in the network (e.g., gNB), another WTRU (e.g., sidelink and/or WTRU-to-WTRU direct communication, etc.).

At 904, the WTRU may be configured (e.g., through RRC signaling) with one or more initial constellation(s). The WTRU may be configured with an initial constellation diagram for each modulation order. The WTRU may be configured with multiple initial constellation diagrams (e.g., a single constellation per sub-band, per precoding resource block group, RB set, or per layer). For example, the first sub-band may be configured with a constellation with 16 symbols (e.g., 4 bits per symbol). The second sub-band may be configured with a constellation with 64 symbols (e.g., 6 bits per symbol). The configured initial constellation diagrams may include, but may not limited to a previously trained and/or learned constellation under a similar condition (e.g. channel conditions, hardware impairments); a trained and/or learned constellation during online constellation learning iterations; a square QAM constellation for the first iteration of online constellation learning.

At 908, the WTRU may be configured (e.g. by RRC signaling) to report one or more constellation performance metrics. The constellation performance metrics may include BER, approximate BER, BLER, and/or throughput, AI/ML model loss, etc. The WTRU may determine one or more constellation performance metrics for one or more configured constellation(s). The WTRU reports one or more of the determined constellation performance metrics to the NW (e.g., through uplink control information (UCI) or medium access control (MAC) control element (CE)).

At 912, the WTRU may receive a command and/or message to start online constellation learning. Triggers to initiate constellation learning may include, but not be limited to: the WTRU is configured to use AI/ML for constellation learning (e.g., for a first time). The WTRU (or the NW) may detect a need to initiate constellation shaping. Examples may include, but not be limited to: AI/ML models drift detection mechanisms at the WTRU and/or the NW may indicate that the AI/ML models have drifted and/or are drifting. The WTRU may enter a geographic region or a cell (e.g., a new cell ID and/or a new registration area) for which the constellation has not been previously trained. The WTRU may compare global positioning system (GPS) coordinates to measure distance to previously trained regions. If distance is above a threshold provided by the NW, the WTRU may signal the NW indicating that the threshold is exceeded, and possibly the distance and/or the current location. The training for the online constellation learning may be periodic, aperiodic, or semi-persistent.

At 916, the WTRU may receive the configuration for the online constellation learning in downlink, which may contain online constellation learning training allocations. The WTRU may receive physical downlink shared channel (PDSCH) resource elements (REs) carrying the symbols modulated by downlink training bits during online constellation learning training allocations. The downlink training bits may include, but may not limited to pseudo-random data bits generated through a seed and/or data bits. The uplink resource allocation or grants for transmitting the online constellation learning feedback (e.g., gradients and/or learned constellation performance metrics).

The WTRU may learn a constellation in the following configurations: for each modulation order greater than 2 bits per symbol through the configured SNRₘᵢₙ and SNR_max for each modulation order; for each modulation order and code rate (e.g., per MCS) through the configured of SNRₘᵢₙ and/or SNRₘₐₓ for each MCS (e.g., learning the constellations for a range of SNR in a given MCS); and/or for each combination of MCS (with its associated SNR range) and hardware/radio impairment class through the configured of SNRₘᵢₙ and/or SNRₘₐₓ for each MCS and partitioned channel BW (e.g., sub-band) with a common class of hardware/radio impairments.

Training related information, which includes, but may not be limited to: seed(s) to recreate the downlink training bits used by the NW; a set of code rate for FEC (e.g., LDPC). A set of code rates may include a code rate for each configured constellation and/or a fixed code rate for all configured constellations.

Training related information may include AI/ML model loss function. The AI/ML model loss function may be different for each configured learned constellation. At 920, the WTRU may compute the estimated downlink training bits by processing the received allocated transmission to produce a multi-bit resolution estimate of the downlink training bits, (e.g., the estimated downlink training bits may be soft bits such as LLRs). The estimated downlink training bits may be computed before FEC decoder, where they are referred to as coded bits and/or raw bits. The estimated downlink training bits may be computed after FEC where they are referred to as decoded bits. The WTRU may use a loss function taking as input the recreated downlink training bits and the estimated downlink training bits to compute the end-to-end loss through the recreated downlink training bits and the estimated downlink training bits. The WTRU may use the gradients with respect to the end-to-end loss to train a single (or multiple) AI/ML model(s) for any receiver functions (e.g., a combination of channel estimator, equalizer, demodulator, and/or channel decoder). The examples of end-to-end loss functions may include, MSE, BCE, and/or approximations of decoded BER, approximate BER, coded BER, BLER, and/or throughput, etc.

Training related information may further include a set of thresholds to monitor the training progress of each configured learned constellation and/or a set of learned constellation performance metrics (e.g., uncoded BER, approximate BER, BLER, and/or throughput, and/or I/ML model loss, etc.). The WTRU may report the set of learned constellation performance metrics to the NW during the online constellation learning iterations. The WTRU may determine the estimated downlink training bits based on a first constellation learning training allocation.

At 924, The WTRU may recreate the transmitted downlink training bits used by the NW. For example, the WTRU may employ a pseudo-random bit generator with the same seeds and pseudo-random bit generator used by the NW if the NW generates downlink training bits via the pseudo-random data bits. The WTRU may utilize the hard decision applied to the estimated downlink training bits as downlink training bits when the CRC check succeeds (e.g., if the NW uses data bits as downlink training bits).

At 928, the WTRU may compute one or more constellation performance metric(s) for one or more initial constellation(s) based on the recreated downlink training bits and the estimated downlink training bits. At 932, the WTRU may determine the training status (e.g., training complete, training incomplete) based on the one or more constellation performance metric(s) for one or more initial constellation(s) and/or one or more configured thresholds.

At 936, the WTRU may compute one or more training parameters (e.g., the gradients of the end-to-end loss with respect to the effective (e.g., precoded) downlink channel estimate), based on the training status (e.g., if training status is training incomplete). The WTRU may use the differentiation chain rule to compute the gradients. The WTRU may use the effective downlink channel estimate when computing the gradients. At 940, the WTRU may transmit online constellation learning feedback to the NW, (e.g., through UCI and/or MAC-CE). At 944, the online constellation learning feedback may include one or more of: the computed one or more constellation performance metric(s) for one or more initial constellation(s), the one or more training parameters, and/or the training status. At 948, the WTRU may use the newly trained constellation in, e.g., its data detection operation.

On the NW side, the NW may configure the WTRU for the online constellation learning based on a received one or more constellation performance metric(s) for one or more initial constellation(s). The NW may train one or more second constellation(s) based on the received online constellation learning feedback from the WTRU. For example, the NW may receive and/or utilize training parameters (e.g., gradients) to train one or more second constellation(s), e.g., via supervised learning. The NW may use the received gradients with respect to the effective (e.g., precoded) downlink channel, and apply the differentiation chain rule for computing the gradients with respect to the trainable second constellation. The NW may train the second constellation by using the gradients with respect to the initial constellation via supervised learning. The NW may utilize the one or more constellation performance metrics to train one or more second constellation(s) using RL. The RL agent at the NW may apply a perturbation vector to the constellations representing the action of RL agent. The perturbation vector may include the perturbations for each symbol point (e.g., 2M values for M-QAM). The NW may configure the WTRU with the one or more second constellation(s), (e.g., through RRC signaling).

Numerical results may be presented for the performance evaluation of the proposed online constellation learning. The simulations may be performed by using Sionna, which is an open-source Python library for the link-level simulations based on TensorFlow.

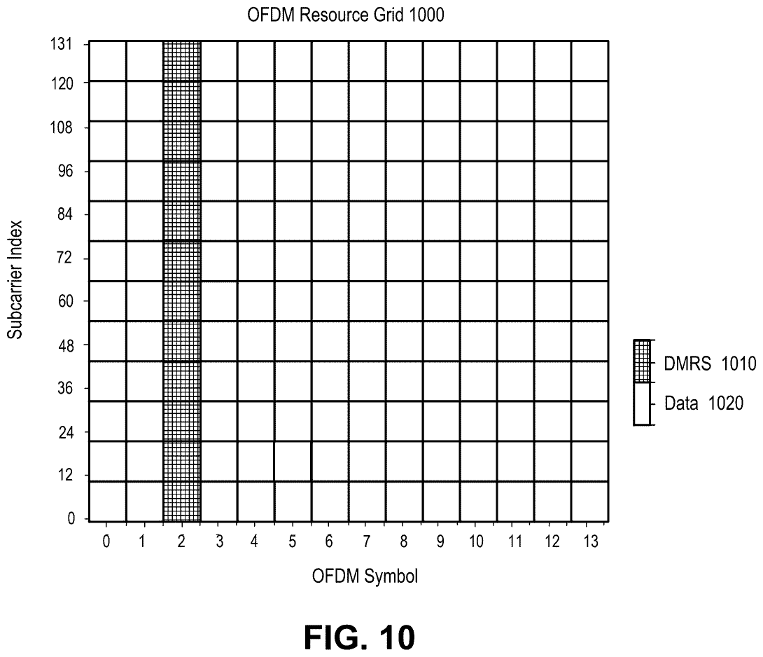

Table 1 may summarize the simulation parameters. The WTRU may be configured with 10 MHz bandwidth with numerology μ=2 (e.g., 60 kHz subcarrier spacing, 11 RBs with 132 subcarriers). FIG. 10 depicts the orthogonal frequency division multiplexing (OFDM) resource grid 1000 with the configured demodulation reference signal (DMRS) 1010 and data 1020 allocations.

Table 2 provides the AI/ML model training parameters. The batch size may be 4096 slots per run. The AI/ML model may be trained for 50 runs. Thus, the model may be trained for 204,800 slots.

Here, the online constellation learning may be performed through supervised learning (e.g., using the gradients transmitted from the WTRU to the NW disclosed herein). During the online constellation learning allocations, two proposed scenarios for the end-to-end learning may be considered: learned constellation plus demapper: the NW may learn the constellation and/or the WTRU may learn the AI/ML demapper. The other scenario may be a learned constellation wherein the NW learns the constellation, while the WTRU customize its non-AI/ML demapper.

TABLE 1
Simulation parameters.

| Scenario | Downlink | |
|---|---|---|
| Number of Tx Antenna at gNB | 1 | |
| Number of Rx Antenna at WTRU | 1 | |
| Channel Model | CDL-B | |
| Delay Spread | 300 | ns |
| Channel Normalization | True (Enabled) | |
| Subcarrier Spacing | 60 | kHz |
| Number of RBs | 11 | |
| Bandwidth | 10 | MHz |
| Number of Bits per Symbol | 6 | bits |
| Code rate | 466/1024 | |
| WTRU Velocity | 10 | km/h |

| | |
|---|---|
| SNR | [10 dB, 20 dB] |

TABLE 2
Al/ML model training parameters

| | |
|---|---|
| Batch Size | 4096 Slots |
| Number of Runs | 50 for Training \| 1 for Test |
| Training Dataset Size | $204 , 800 Slots = 4096 \frac{Slots}{Run} \times 50 Runs$ |
| Optimizer | Adam |
| Learning Rate | 0.001 |
| Model Params | 128 for Constellation (i.e., Learned QAM) |
| | 17,798 for Demapper |

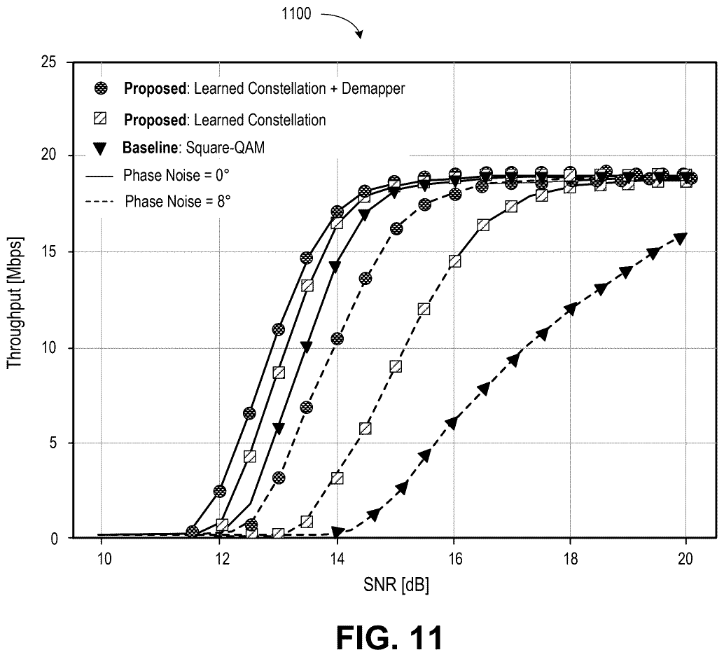

FIG. 11 is a plot 1100 of a throughput performance of learned constellation and traditional square-QAM. FIG. 11 depicts the throughput performance versus SNR, where two proposed scenarios may be compared with the traditional square-QAM. Two hardware impairment scenarios to consider include: (i) phase noise equals 0° and/or (ii) phase noise equals 8°. When phase noise is 0°, learned constellation may achieves 0.4 dB improvement in SNR compared to the traditional square-QAM. When constellation and/or demapper are learned together, the performance improvement may increase (e.g., approximately 0.6 dB improvement in SNR at 15 Mbps throughput). When the hardware impairments are introduced, the performance improvement may further increase. For instance, the learned constellation and/or demapper improves the throughput performance compared to the traditional square-QAM by 4.8 dB improvement in SNR at 15 Mbps throughput.

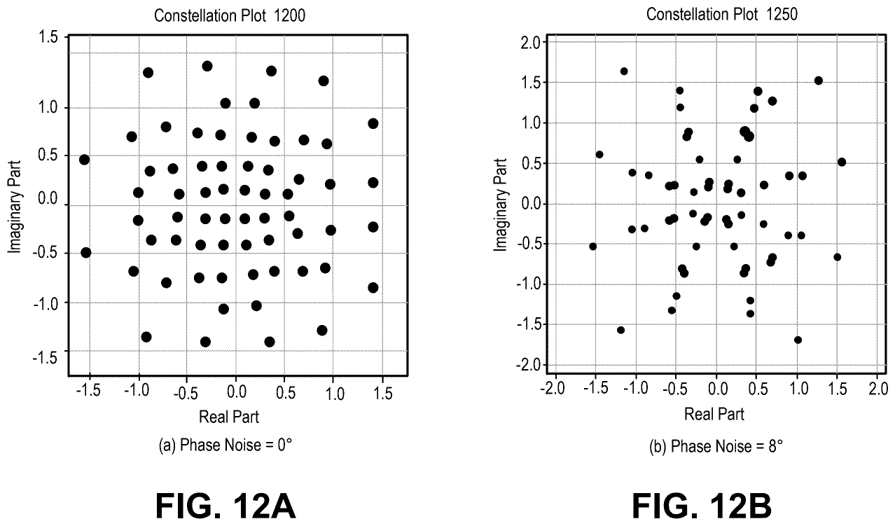

FIG. 12A and FIG. 12B depict the real and imaginary parts of each symbol points in the learned constellations when the constellation and/or demapper are learned together. FIG. 12A depicts the learned constellation 1200 for 6 bits per symbol when the phase noise is 0°. When the hardware impairment is introduced with the phase noise of 8°, the symbols in the learned constellation may converge in the amplitude domain, while diverging from each other in angular domain as shown in FIG. 12B. FIG. 12B depicts learned constellations 1250 for 6 bits per symbol wherein phase noise equals 8°.

A solution may include transmitter-side training for online constellation learning in uplink. Online constellation learning in uplink may improve the end-to-end system performance (e.g., BER, approximate BER, BLER, and/or throughput, etc.), by adapting to the hardware and/or radio impairments and/or dynamic channel conditions. The proposed solution may present the steps and/or procedures enabling online constellation learning in uplink through transmitter-side training. The proposed solution may first enable configuring a WTRU as the transmitter with a set of initial constellations (e.g., square QAM and/or non-square QAM). Afterwards, the WTRU may use the uplink training bits (e.g., data bits, pseudo-random data bits) to create the modulated symbols, which may be transmitted over-the-air to the NW. By using the uplink training bits, the NW may calculate the gradients and/or learned constellation performance metrics (e.g., AI/ML model loss, BER, approximate BER, BLER, and/or throughput, etc.). The WTRU may then send one or more constellation performance metrics to the WTRU as online constellation learning feedback. The WTRU may train the constellation through online constellation learning feedback. The WTRU may report the learned constellation to the NW.

The constellation learning may be a function based on two AI/ML models: one residing at the WTRU, and one residing at the NW. The AI/ML model residing at the WTRU, referred to as constellation (or constellation mapper), may map the information bits at the WTRU to complex constellation symbols to be transmitted to the NW through the uplink transmission chain (e.g., resource mapping, precoding, etc.). The AI/ML model residing at the NW, referred to as the soft symbol demapper, may map the equalized complex symbols from the WTRU to LLRs (or hard bits). The LLRs (or hard bits) may then be converted back to information bits. The application of AI/ML is the online constellation learning. The stages of the AI/ML process may include, but not be limited to the following steps:

At the input data stage, the constellation may associate with uplink training bits. The soft symbol demapper may be associated with equalized complex symbols at the NW. The estimated noise power at the NW may also be a part of the AI/ML model input.

At the preprocessing stage, the constellation may associate with an optional preprocessing applying channel encoding to the uplink training bits. The soft symbol demapper may associate with concatenation of the real and/or imaginary parts of the complex symbols to obtain the real-valued input to the AI/ML model.

At the stage of the application of the AI/ML model, the constellation may be associated with an example AI/ML model for the constellation mapper as depicted in FIG. 6. The example AI/ML model may be comprised of an input layer, multiple fully connected layers 608a, 608b, 608c, and/or an output layer 612. During the output data phase, assuming that the constellation to be learned has an order of M, e.g., M constellation points, the input 604 to the AI/ML model for the constellation mapper may be a codeword with log 2 Mbits and the output of the AI/ML model for the constellation mapper are the real and/or imaginary parts 612 of the constellation point associated to the input codeword.

The example AI/ML model may be comprised of an input layer, multiple fully connected layers, and/or an output layer. The soft symbol demapper may be associated with an example AI/ML model as depicted in FIG. 7. The example AI/ML model may be comprised of an input layer 704, multiple fully connected layers 708a, 708b, 708c, and/or an output layer 712.

Assuming that the constellation to be learned has an order of M, e.g., M constellation points, the inputs to the AI/ML model for the soft symbol demapper are the real 706a and/or imaginary 706b parts of the received equalized symbol at the WTRU. The inputs 704 may also be an estimate of the noise power 706c at the WTRU and/or the output 712 of the AI/ML model for the soft symbol demapper are the log₂ M LLRs 716 associated to the log₂ M bits of the original codeword input to the constellation mapper.

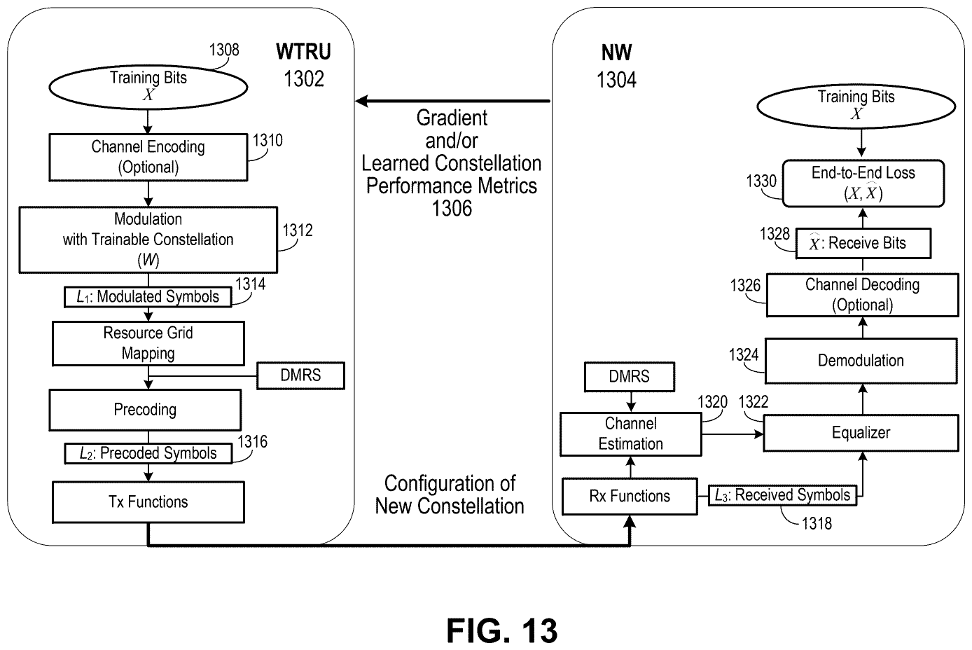

In the training phase, the WTRU may send the uplink training bits for the online constellation learning as shown in FIG. 13. FIG. 13 is a diagram depicting WTRU procedures for transmitter-side training for online constellation learning in uplink. The training of the constellation may be performed at the transmitter-side (e.g., WTRU 1302-side) by using online constellation learning feedback. As explained herein, the training may be performed through either supervised learning and/or reinforcement learning.

In supervised learning, the transmission and/or reception blocks involved in the end-to-end transmission (at the WTRU 1302 and/or the NW 1304, respectively) may be differentiable or approximated as such. At 1306, the NW 1304 may compute the gradients of end-to-end loss and/or performance loss metrics with respect to the trainable parameters in the constellation, and transmit these metrics to the WTRU. The WTRU 1302 may employ a modulator with trainable and/or learned constellation. The trainable parameters in the constellation may be denoted W as shown in at 1312. The WTRU 1302 may modulate the uplink training bits X 1308 (or coded uplink training bits through channel encoder 1310), denoted by L₁, as shown at 1314. The WTRU 1302 may transmit the precoded symbols denoted by L₂ as shown at 1316. The NW 1304 may extract the received data symbols denoted by L₃ as shown at 1318. After performing the channel estimation 1320, equalization 1322, demodulation 1324, and/or channel decoding 1326 (optional), the NW 1304 may obtain the received bits denoted by \hat{X} at 1328.

The NW 1304 may compute the end-to-end loss 1330 by using X and/or \hat{X}, denoted by Loss (X, [symbol] The NW 1304 may compute and/or report the learned constellation performance metrics (e.g., uncoded BER, approximate BER, BLER, and/or throughput, and/or AI/ML model loss, etc.). By using the differentiation chain rule and/or assuming all transmission/reception blocks are differentiable (or can be approximated), the WTRU 1302 and/or the NW 1304 may compute the gradients of end-to-end loss 1330 with respect to the trainable parameters 1312 in the constellation (e.g., ∂Loss(X,\hat{X})/∂W). By using the differentiation chain rule, the gradients of end-to-end loss with respect to the trainable weights in the constellation may be expanded as:

$$\frac{\partial Loss ( X , \hat{X} )}{\partial W} = \frac{\partial Loss ( X , \hat{X} )}{\partial \hat{X}} \times \frac{\partial \hat{X}}{\partial {L}_{3}} \times \frac{\partial {L}_{3}}{\partial {L}_{2}} \times \frac{\partial {L}_{2}}{\partial {L}_{1}} \times \frac{\partial {L}_{1}}{\partial W}$$

The NW 1304 may compute the gradients

$$\frac{\partial Loss ( X , \hat{X} )}{\partial \hat{X}} \times \frac{\partial \hat{X}}{\partial {L}_{3}} \times \frac{\partial {L}_{3}}{\partial {L}_{2}} ,$$

and report it to the WTRU 1302. The WTRU 1302 may compute the gradients of end-to-end loss with respect to the trainable parameters 1312 in the constellation (e.g., ∂Loss(X,\hat{X})/∂w) by the received gradients and/or computed gradients

$$\frac{\partial {L}_{2}}{\partial {L}_{1}} \times \frac{\partial {L}_{1}}{\partial W} .$$

The WTRU 1302 may train the parameters through supervised learning. The WTRU 1302 may use a learning algorithm, e.g., SGD, ADAM, RMSProp.

In reinforcement learning, the NW may compute the learned constellation performance metrics (e.g., uncoded BER, approximate BER, BLER, and/or throughput, and/or AI/ML model loss, etc.). The NW may send the learned constellation performance metrics to the WTRU.

The WTRU may train the constellation through reinforcement learning. For example, a reinforcement learning agent may be located at the WTRU. Symbol points in the constellation and/or other metrics (such as SNR/SINR of the channel) may represent the state. The WTRU may calculate the reward by using the learned constellation performance metrics. For example, the reward may be a vector constructed from a metric associated with each perturbation, (e.g., mean BCE taken over all REs with the same perturbation). An agent may take an action to update the symbol points in the learned constellation. The WTRU may take an action (e.g., the agent at the WTRU may take an action) to update the symbol points in the learned constellation. For example, the agent may apply a perturbation vector to the constellations representing the action of reinforcement learning agent. The perturbation vector may include the perturbations for each symbol point in the learned constellation. The decided action by the agent moves the environment from its current state to a new state.

The NW may initiate the WTRU capability exchange process by sending the UECapabilityEnquiry RRC message to the WTRU. This message may request specific information regarding the WTRU's capabilities. The NW may include parameters in this message to specify which capabilities it has interest. The NW may specify parameters related to WTRU's capability in supporting online constellation learning in uplink in UECapabilityEnquiry message (e.g., the capability of receiving online constellation learning feedback, etc.).

Upon receiving the UECapabilityEnquiry RRC message, the WTRU may respond with the UECapabilityInformation RRC message accordingly. This message may include detailed information about the WTRU's capabilities. During the WTRU capability exchange process between the WTRU and/or the NW, the following key parameters related to the AI/ML functions include, but not be limited to: an indicator of whether online constellation learning in uplink is supported or not; an indicator of whether using one or more learned constellation (e.g., non-square QAM) is supported or not; an indicator of whether the configuration of multiple learned constellation diagrams is supported or not; an indicator of whether receiving online constellation learning feedback (e.g., gradients and/or learned constellation performance metrics) is supported or not; an indicator of whether performing online constellation learning through supervised learning is supported or not; an indicator of whether performing online constellation learning through reinforcement learning is supported or not; an indicator of whether generating the uplink training bits is supported or not (e.g., the WTRU may generate the uplink training bits through a pseudo-random bit generator with the configured seeds by the NW and/or the WTRU may generates the uplink training bits through the data bits); an indicator of whether generating pseudo-random perturbations for creating perturbations for groups of REs is supported or not; and/or an indicator of whether reporting one or more of second (e.g., trained) constellation(s) is supported or not.

Through WTRU capability exchange process, the NW may know the WTRU's capability to support the transmitter-side training of constellation learning in uplink and use the learned constellation. For a WTRU capable of supporting such a function and/or feature, the key parameters should be configured by the NW, which may include, but not limited to: the configuration for one or more initial constellation(s). The WTRU may be configured with an initial constellation diagram for each modulation order. The WTRU may be configured with multiple initial constellation diagrams, (e.g., a single constellation per sub-band, per precoding resource block group, or RB set). For example, the first sub-band may be configured with a constellation with 16 symbols (e.g., 4 bits per symbol), while the second sub-band may be configured with a constellation with 64 symbols (e.g., 6 bits per symbol). The configured initial constellation diagrams may include, but may not be limited to: a previously trained and/or learned constellation under a similar condition (e.g. channel conditions, hardware impairments); a trained and/or learned constellation during online constellation learning iterations; and a square QAM constellation for the first iteration of online constellation learning.

The configuration for online constellation learning training allocations: may include a set of PUSCH REs on which the WTRU transmits the symbols modulated by uplink training bits. The uplink training bits may include, but may not limited to: pseudo-random data bits generated through a seed. For example, the WTRU may generate the uplink training bits through a pseudo-random bit generator with the configured seeds. The uplink training bits may further include data bits. For example, the WTRU may generate the uplink training bits through the data bits. The configuration may further include: seed(s) to generate the uplink training bits at the NW: seed(s) to generate pseudo-random perturbations for creating perturbations for groups of REs; configuration about which group of REs are associated with which perturbation; and/or the code rate of FEC code (e.g., LDPC).

The online constellation learning training may be periodic, aperiodic, or semi-persistent. The configuration(s) for learning a constellation may include: for each modulation order greater than 2 bits/symbol through the configured SNRₘᵢₙ and/or SNRₘₐₓ for each modulation order; for each modulation order and code rate (e.g., per MCS) through the configured of SNRₘᵢₙ and SNRₘₐₓ for each MCS (e.g., learning the constellations for a range of SNR in a given MCS); and/or for each combination of MCS (with its associated SNR range) and hardware/radio impairment class through the configured of SNRₘᵢₙ and SNRₘₐₓ for each MCS and partitioned channel BW having a common class of hardware/radio impairments.

Additional key parameters may include the downlink resource allocation to receive the online constellation learning feedback (e.g., gradients and/or learned constellation performance metrics). The WTRU may receive the gradients of the end-to-end loss with respect to the effective uplink channel estimate computed by the NW. The NW may determine, and/or the WTRU may receive (e.g., through DCI or MAC-CE), one or more constellation performance metric(s) for one or more configured constellation(s). The constellation performance metrics may include BER, approximate BER, BLER, and/or throughput, and/or AI/ML model loss, etc. The training related information may include, but may not limited to: the learning algorithm, learning rates, and/or regularization parameters, etc.; the total number of training sessions; and/or the online constellation learning through supervised learning or reinforcement learning.

The following signals may be defined to enable the WTRU (or NW) to detect the need for initiating online constellation learning in uplink, and/or to enable the WTRU to use the learned constellation(s): a request to report its hardware impairment information (e.g., phase noise, I/Q imbalance, carrier frequency offset, and/or PA nonlinearities) transmitted from the NW to the WTRU (e.g., through RRC signaling); a report with the hardware impairment information transmitted from the WTRU to the NW (e.g., through RRC signaling); training activation for the online constellation learning transmitted from the NW to the WTRU (e.g., through DCI and/or MAC-CE); configuration for online constellation learning training allocations transmitted from the NW to the WTRU; learned constellation performance metrics transmitted from the NW to the WTRU (e.g., through DCI and/or MAC-CE); gradients of the end-to-end loss with respect to the effective (e.g., precoded) uplink channel transmitted from the NW to the WTRU; online constellation learning feedback transmitted from the NW to the WTRU; configuration for online constellation learning through supervised learning transmitted from the NW to the WTRU; configuration for online constellation learning through reinforcement learning transmitted from the NW to the WTRU; an indication that training is complete transmitted from the WTRU to the NW; an indication that training is complete transmitted from the NW to the WTRU; and/or a report with one or more second (e.g., trained) constellation(s) transmitted from the WTRU to the NW.

The procedures for enabling the transmitter-side training for online constellation learning in uplink are detailed below and summarized in FIG. 14. FIG. 14 is a flowchart depicting WTRU procedures for transmitter-side training for online constellation learning in uplink. The NW may refer to any node in the network (e.g., gNB), another WTRU (e.g., sidelink and/or WTRU-to-WTRU direct communication), etc.

At 1404, the WTRU may be configured (e.g., through RRC signaling) with one or more initial constellation(s). The WTRU may be configured with an initial constellation diagram for each modulation order. The WTRU may be configured with multiple initial constellation diagrams, e.g., a single constellation diagram per sub-band, per precoding resource block group, resource block (RB) set, or per layer. For example, the first sub-band may be configured with a constellation with 16 symbols (e.g., 4 bits per symbol). The second sub-band may be configured with a constellation with 64 symbols (e.g., 6 bits per symbol). The configured initial constellation diagrams may include, but may not limited to: a previously trained and/or learned constellation under a similar condition (e.g., channel conditions and/or hardware impairments); a trained and/or learned constellation during online constellation learning iterations; and/or a square QAM constellation for the first iteration of online constellation learning.

At 1408, the WTRU may receive a command and/or message to start online constellation learning. Triggers to initiate constellation learning may include, but may not be limited to: the WTRU may use AI/ML for constellation learning (e.g., for a first time). The WTRU (or the NW) may detect a need to initiate constellation shaping. Examples include, but may not be limited to: AI/ML models drift detection mechanisms at the WTRU and/or the NW indicate that the AI/ML models have drifted and/or are drifting. The WTRU may enter a geographic region or a cell (e.g., a new cell ID and/or a new registration area) for which the constellation may have not previously trained. Examples include, but may not be limited to: the WTRU may compare GPS coordinates to measure distance to previously trained regions. If distance is above a threshold provided by the NW, the WTRU may signal the NW indicating the threshold is exceeded, and/or possibly the distance and/or the current location. The training for the online constellation learning may be periodic, aperiodic, or semi-persistent.

At 1412, the WTRU may receive the configuration for the online constellation learning in uplink. The configuration may contain the following information: online constellation learning training allocations. At 1416, online constellation learning training allocations may include a set of PUSCH REs on which the WTRU transmits the symbols modulated by uplink training bits. The uplink training bits may include, but may not limited to: pseudo-random data bits generated by initializing a pseudo-random data generator with a seed value. The uplink training bits may further include data bits.

The configuration may further contain downlink resource allocation to receive the online constellation learning feedback (e.g., gradients and/or learned constellation performance metrics). The WTRU may receive the gradients of the end-to-end loss with respect to the effective uplink channel estimate on the downlink resources, (e.g., signal by DCI or MAC-CE). The WTRU may receive one or more constellation performance metric(s) for one or more configured constellation(s) on downlink resources, (e.g., signaled by DCI or MAC-CE). The constellation performance metrics may include BER, approximate BER, BLER, and/or throughput, AI/ML model loss, etc.

At 1420, the WTRU may be configured to learn a constellation as follows: for each modulation order greater than 2 bits/symbol through the configured SNRₘᵢₙ and SNRₘₐₓ for each modulation order; for each modulation order and code rate (e.g., per MCS) through the configured of SNRₘᵢₙ and/or SNRₘₐₓ for each MCS (e.g., learning the constellations for a range of SNR in a given MCS); and/or for each combination of MCS (with its associated SNR range) and hardware/radio impairment class through the configured of SNRₘᵢₙ and/or SNRₘₐₓ for each MCS and partitioned channel BW (e.g., sub-band) with a common class of hardware/radio impairments.

The configuration may further contain training related information, which includes, but may not be limited to: seed(s) to generate the uplink training bits at the WTRU; seed(s) to generate pseudo-random perturbations for creating perturbations for groups of REs; configuration about which group of REs are associated with which perturbation; and/or a set of code rate for FEC (e.g., LDPC). A set of code rates may include a code rate for each configured constellation and/or a fixed code rate for all configured constellations.

At 1424, the WTRU may be configured to perform online constellation learning through supervised learning. At 1428, The WTRU may receive the gradients of the end-to-end loss with respect to the effective uplink channel estimate computed by the NW as online constellation learning feedback. At 1432, the WTRU may determine the gradients of end-to-end loss with respect to the trainable parameters in the constellation by using the online constellation learning feedback. At 1436, the WTRU may train one or more second constellation(s) through supervised learning by using the gradients of end-to-end loss with respect to the trainable weights. The WTRU may use a learning algorithm, e.g., stochastic gradient decent (SGD), adaptive moment estimation (ADAM), and/or root mean square propagation (RMSProp), etc.

Additionally or alternatively, at 1440, the WTRU may perform online constellation learning through reinforcement learning. At 1444, the WTRU may receive the learned constellation performance metrics computed by the NW as online constellation learning feedback.

At 1448, the WTRU may compute a reward by using the received learned constellation performance metrics. The reward may be a vector constructed from the received learned constellation performance metrics associated with each perturbation (e.g., mean AI/ML model loss over all REs with the same perturbation). At 1452, the WTRU may train one or more second constellation(s) through reinforcement learning by using reward, e.g., the reinforcement learning agent at the WTRU may take an action to update the symbol points in the learned constellation based on the reward of the action. The reinforcement learning agent at the WTRU may apply a perturbation vector to the constellations representing the action of reinforcement learning agent. The perturbation vector may include the perturbations for each symbol point in the learned constellation (e.g., 2M values for M-QAM constellation).

At 1456, the WTRU may report one or more second (e.g., trained) constellation(s) to the NW. The reporting may be transmitted as UCI on PUCCH/PUSCH, as MAC-CE, and/or as RRC signaling. At 1460, the WTRU may determine if training is complete. At 1464, the WTRU may receive an indication to stop online constellation learning (e.g., training is complete). At 1468, the WTRU may use the newly trained constellation in uplink data transmission.

What is claimed is:

1. A wireless transmit/receive unit (WTRU) comprising:
a processor and a memory, the processor configured to:
receive first configuration information from a network device, wherein the first configuration information comprises one or more initial constellations associated with an AI/ML constellation model;
receive second configuration information from the network device, the second configuration information comprises an allocation associated with online constellation learning training;
determine one or more estimated downlink training bits based on the allocation associated with online constellation learning training and the one or more initial constellations;
recreate one or more downlink training bits used by the network device;
determine one or more constellation performance metrics for the one or more initial constellations based on the estimated downlink training bits and the recreated downlink training bits; and
send a report to the network device based on the one or more constellation performance metrics for the one or more initial constellations.

2. The WTRU of claim 1, wherein the constellation performance metrics comprise one or more of bit error rate (BER), approximate BER, block error rate (BLER), throughput, or artificial intelligence/machine learning (AI/ML) model loss.

3. The WTRU of claim 1, wherein the downlink training bits comprise one or more of pseudo-random data bits or data bits.

4. The WTRU of claim 1, wherein second configuration information comprises one or more seed values; and
wherein the processor is configured to recreate the downlink training bits using the one or more seed values and a pseudo-random number generator.

5. The WTRU of claim 1, wherein the processor is configured to recreate the downlink training bits by running a cyclic redundancy check (CRC) on the estimated downlink training bits.

6. The WTRU of claim 1, wherein the allocation associated with online constellation learning training comprises physical downlink shared channel (PDSCH) resource elements (REs).

7. The WTRU of claim 1, wherein the second configuration information further comprises one or more of an uplink resource allocation, one or more grants for transmitting online constellation feedback, or online constellation training information.

8. The WTRU of claim 1, wherein the second configuration information further comprises one or more of an uplink resource allocation for sending the report and wherein the processor is configured to send the report on the uplink resource allocation.

9. The WTRU of claim 1, wherein the processor is further configured to:
determine training status based on the one or more constellation performance metrics, wherein the training status indicates whether online constellation learning is complete, and wherein the report comprises an indication of the training status.

10. The WTRU of claim 9, wherein the processor is further configured to:
determine one or more training parameters based on the determined training status, wherein training parameters comprise one or more gradients of an end-to-end loss with respect to a downlink channel estimate, and wherein the determined training status indicates whether online constellation learning is complete or not, and wherein the report comprises an indication of the training parameters.

11. A method implemented by a wireless transmit/receive unit (WTRU), the method comprising:
receiving first configuration information from a network device, wherein the first configuration information comprises one or more initial constellations associated with an AI/ML constellation model;
receiving second configuration information from the network device, the second configuration information comprises an allocation associated with online constellation learning training;
determining one or more estimated downlink training bits based on the allocation associated with online constellation learning training and the one or more initial constellations;
recreating one or more downlink training bits used by the network device;
determining one or more constellation performance metrics for the one or more initial constellations based on the estimated downlink training bits and the recreated downlink training bits; and
sending a report to the network device based on the one or more constellation performance metrics for the one or more initial constellations.

12. The method of claim 11, wherein the constellation performance metrics comprise one or more of bit error rate (BER), approximate BER, block error rate (BLER), throughput, or artificial intelligence/machine learning (AI/ML) model loss.

13. The method of claim 11, wherein the downlink training bits comprise one or more of pseudo-random data bits or data bits.

14. The method of claim 11, wherein second configuration information comprises one or more seed values and a configuration to recreate the downlink training bits using the one or more seed values and a pseudo-random number generator.

15. The method of claim 11, further comprising:
recreating the downlink training bits by running a cyclic redundancy check (CRC) on the estimated downlink training bits.

16. The method of claim 11, wherein the allocation associated with online constellation learning training comprises physical downlink shared channel (PDSCH) resource elements (REs).

17. The method of claim 11, wherein the second configuration information further comprises one or more of an uplink resource allocation, one or more grants for transmitting online constellation feedback, or online constellation training information.

18. The method of claim 11, wherein the second configuration information further comprises one or more of an uplink resource allocation for sending the report, wherein the report is sent on the uplink resource allocation.

19. The WTRU of claim 11, further comprising:
determining training status based on the one or more constellation performance metrics, wherein the training status indicates whether online constellation learning is complete, and wherein the report comprises an indication of the training status.

20. The WTRU of claim 19, further comprising:
determining one or more training parameters based on the determined training status, wherein training parameters comprise one or more gradients of an end-to-end loss with respect to a downlink channel estimate, and wherein the determined training status indicates whether online constellation learning is complete or not, and wherein the report comprises an indication of the training parameters.
